(19) United States
(12) Patent Application Publication
(10) Pub. No.: US 2014/0033692 A1
(43) Pub. Date: Feb. 6, 2014

(54) SYSTEM AND METHOD TO CHARGE AND DISCHARGE AN ACCUMULATOR

(71) Applicants: Bryan E. Nelson, Lacon, IL (US); Jeremy T. Peterson, Washington, IL (US)

(72) Inventors: Bryan E. Nelson, Lacon, IL (US); Jeremy T. Peterson, Washington, IL (US)

(73) Assignee: Caterpillar Inc., Peoria, IL (US)

(21) Appl. No.: 13/563,898

(22) Filed: Aug. 1, 2012

(51) Int. Cl. F15B 1/027

(52) U.S. Cl. 60/327; 60/413

(57) ABSTRACT

A method for charging an accumulator is disclosed. The method includes pumping pressurized fluid from an output port of a hydraulic pump to the accumulator to charge the accumulator, and flowing makeup fluid from a hydraulic actuator system to an input port of the hydraulic pump.

### TECHNICAL FIELD

The present disclosure relates generally to hydraulic circuits with accumulators. Specifically, the disclosure relates to methods and systems to charge and/or discharge an accumulator.

### BACKGROUND

Power sources for machines may power multiple functions of the machine. For example, a power source, such as an engine, may power a propulsion system to move a machine from site to site, an implement system to perform work on a site, and auxiliary systems including a hydraulic system powering a fan, and/or operator comfort systems such air conditioning. Generally, not all machine systems draw maximum power simultaneously. But, traditionally, the power source has been sized to power the load when all the machine systems are operating, at full power, at once.

With fuel prices rising, owners and operators of machines desire more fuel efficient machines to maintain or lower their operating costs and compete effectively. Larger power sources, running below their capacity, are generally not as fuel efficient as smaller power sources providing the same power level at their full capacity. Larger power sources are generally more expensive, as well. Hybrid power systems have been developed to store energy when the demand on a machine's primary power source (such as an engine) is running below full capacity. This energy may be recovered and used at a later time to supplement the power provided by the primary power source, when the machine's power demand is more than the primary power source can supply. This allows a smaller primary power source to be specified for the machine.

One type of hybrid machine, stores energy in the form of pressurized fluid in high pressure accumulators. These machines have at least one hydraulic powered system, such as, for example, an implement system, a steering system, a brake system, a fan system, and/or a hydrostatic transmission system. When the energy consumption of the machine and the demand for one of these hydraulic systems is low, that hydraulic system may pump pressurized fluid into the high pressure accumulator(s) to be stored. The energy stored may be used to operate the machine at another time, when needed.

Closed hydraulic systems are generally more fuel efficient than open hydraulic systems. Instead of dumping fluid, and energy, back into a fluid tank, a closed hydraulic system circulates the fluid back through a pump. The amount of fluid entering the pump, in closed systems, must be substantially equal to the amount of fluid discharged from the pump. Otherwise, damage to the pump 204 may occur.

Open hydraulic systems sometimes provide performance enhancements that are not possible in closed hydraulic systems. Open hydraulic systems may also be easier to control than closed hydraulic systems. Consequently, some machines may utilize a combination of both closed hydraulic systems and open hydraulic systems. Often an implement actuation system will include an open hydraulic system.

When closed hydraulic systems are used to charge accumulators, the fluid pumped into the accumulator must be replaced such that the same amount of fluid discharged from the pump, is returned to the pump. When the pressurized fluid stored in the accumulator is released to re-enter the pump, an equal amount of fluid must be discharged to another receptacle or fluid receiving device, rather than be re-circulated to re-enter the pump. This replacement or additionally discharged fluid is sometimes called makeup fluid. Some closed hydraulic systems include low pressure accumulators to provide or receive the makeup fluid. But, these low pressure accumulators add cost and complexity to the system, and require additional space in the machine.

World Intellectual Property Publication WO20111120486A3 discloses a hydraulic fan drive which has a hydraulic pump, a hydraulic motor, and a pressure line. The hydraulic pump can have its swept volume adjusted and is assigned a pressure control valve arrangement for regulating a pump pressure by adjustment of the swept volume. The hydraulic motor drives an impeller wheel. The pressure line is connected to a pressure input of the hydraulic motor. A pressure medium can be conveyed into the pressure line by the hydraulic pump. Fan drives of this type can be used, for example, in construction machines, agricultural and forestry machines, in conveying technology, in lorries and omnibuses and in rail vehicles. The disclosure is based on the problem of developing a hydraulic fan drive of this type in such a way that it can be used for the recuperation of energy. This problem is solved by the fact that a hydraulic accumulator is connected to the pressure line and the hydraulic motor can have its displacement adjusted. In the case of a hydraulic fan drive according to the invention, energy can be buffer-stored on account of the hydraulic accumulator which is connected to the pressure line by feeding in pressure medium beyond the amount which is displaced by the hydraulic motor, which energy becomes free in other operations on the machine, for example during a braking operation or during the lowering of a load. The pressure changes in the pressure line which are associated with the buffer storage and the output of energy can be compensated for by a change in the displacement of the hydraulic motor in such a way that the torque which is output by the hydraulic motor corresponds to the desired fan speed.

### SUMMARY OF THE INVENTION

In one aspect, a method for charging an accumulator is disclosed. The method includes allowing fluid to flow from an output port of a pump/motor device, through a closed circuit, to an input port of the pump/motor device. Further, the method includes redirecting fluid from the output port of the pump/motor device to flow to the accumulator, and directing makeup fluid from a hydraulic actuator system to flow to the input port of the pump/motor device.

In another aspect, a method for discharging an accumulator is disclosed. The method includes allowing fluid to flow from the output port of a pump/motor device, through a closed circuit, to the input port of the pump/motor device. Further the method includes allowing fluid to flow from the accumulator to the input port of the pump/motor device to drive the pump/motor device, and redirecting the flow of fluid from the output port of the pump/motor device to a fluid tank.

In another aspect, a method for charging an accumulator and driving a hydraulic motor is disclosed. The method includes allowing fluid from an output port of a hydraulic pump to flow to the accumulator to charge the accumulator, and allowing fluid from the output port of the hydraulic pump to flow to an input port of the hydraulic motor to drive the hydraulic motor. Further, the method includes directing makeup fluid from a hydraulic actuator system to an input port of the hydraulic pump, and allowing fluid from an output port of the hydraulic motor to flow to the input port of the hydraulic pump.

In another aspect, a method for discharging an accumulator and driving a hydraulic motor is disclosed. The method includes allowing fluid to flow from the output port of a pump/motor device to the input port of a hydraulic motor, through the hydraulic motor, and from the output port of the hydraulic motor to the input port of the pump/motor device. Further, the method includes allowing fluid to flow from the accumulator to the input port of the pump/motor device to drive the pump/motor device, and allowing fluid to flow from the accumulator to the input port of the hydraulic motor to drive the motor. The method also includes redirecting the flow of fluid from the output port of the hydraulic motor and the output port of the pump/motor device to a fluid tank.

In another aspect, a hydraulic system to charge and discharge an accumulator is disclosed. The system includes a variable displacement pump/motor, a hydraulic motor, an accumulator, and a hydraulic actuator system. The variable displacement pump/motor includes a pump input port and a pump output port. The hydraulic motor includes a motor input port and a motor output port. The motor input port is selectively fluidly connected to one of the pump input port and the pump output port. The motor output port is selectively fluidly connected to the other of the pump input port and the pump output port. The accumulator is selectively fluidly connected to the pump output port for charging. The hydraulic actuator system is configured to power an actuator, and is selectively fluidly connected to the pump input port.

### BRIEF DESCRIPTION OF THE DRAWINGS

FIG. 1 is a pictorial illustration of an exemplary machine.

FIG. 2 is a schematic illustration of an exemplary hydraulic circuit.

FIG. 3 is a flow chart of an exemplary method to charge of an accumulator.

FIG. 4 is a schematic illustration of the exemplary hydraulic circuit of FIG. 2 with the valves in different positions.

FIG. 5 is a flow chart of an exemplary method to discharge an accumulator.

FIGS. 6-7 are schematic illustrations of the exemplary hydraulic circuit of FIGS. 2 and 4 with the valves in different positions.

### DETAILED DESCRIPTION

Reference will now be made in detail to specific embodiments or features, examples of which are illustrated in the accompanying drawings. Generally, corresponding or similar reference numbers will be used, when possible, throughout the drawings to refer to the same or corresponding parts.

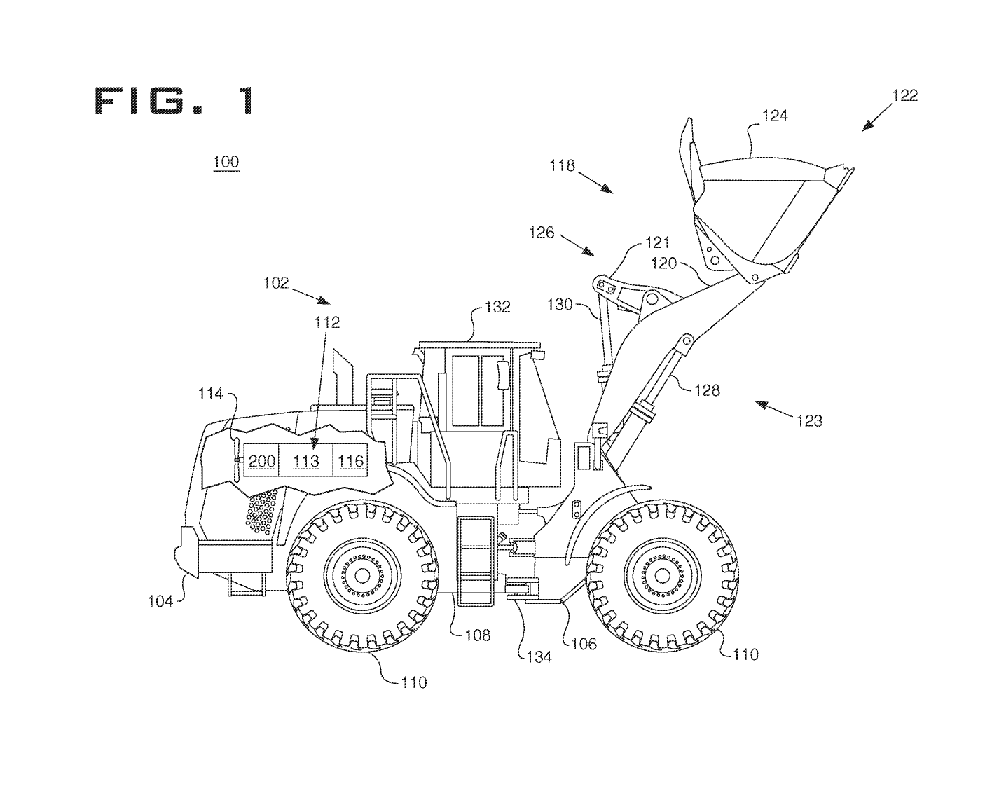

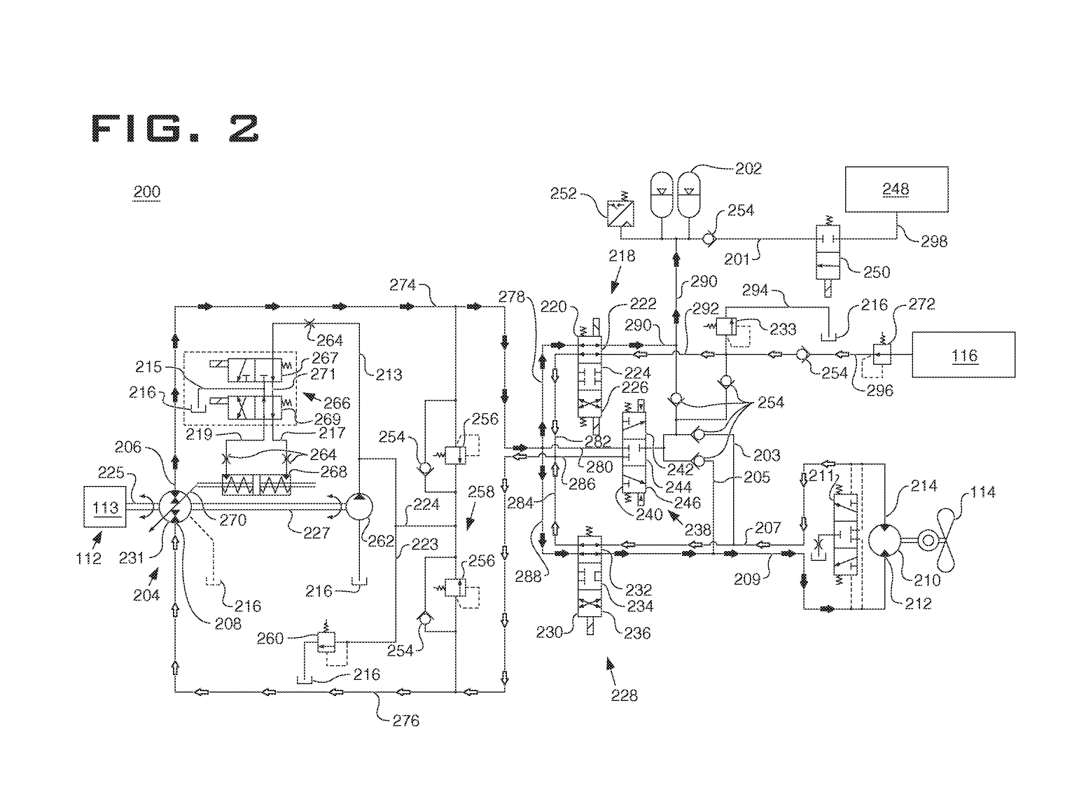

Referring to FIG. 1, there is shown a machine 100 according to one embodiment. In the embodiment illustrated, machine 100 is depicted as a vehicle, and in particular a wheel loader 102. In other embodiments, the machine 100 may include any system or device for doing work with a system 200 for selectively powering a hydraulic motor 210 (shown in relation to FIG. 2) and selectively charging an accumulator 202 (shown in relation to FIG. 2) which would be known to an ordinary person skilled in the art now or in the future.

The machine 100 may include but is not limited to machines that perform some type of operation associated with a particular industry such as mining, construction, farming, transportation, etc. and operate between or within work environments (e.g. construction site, mine site, power plants, on-highway applications, marine applications, etc.). Non-limiting examples of vehicle 104 include cranes, earthmoving vehicles, mining vehicles, backhoes, loaders, material handling equipment, and farming equipment.

Wheel loader 102 includes a frame 104 having a front frame unit 106, a rear frame unit 108, and an articulation joint 134 coupling together frame units 106 and 108. A power source 112 is mounted to frame 104, as is an operator cab 132. The operator cab 132 may include operator interface devices (not shown) for an operator to control machine 100. A set of ground engaging devices 110 are coupled with frame 104 in a conventional manner.

In the embodiment illustrated, power source 112 includes an internal combustion engine 113. In alternative embodiments, power source 112 may include one or more fuel cells, turbines, batteries, and/or other power sources known to ordinary persons skilled in the art now or in the future. Power source 112 powers hydraulic system 200. Hydraulic system 200 may power a fan 114 for cooling power source 112 or other machine 100 components. Power source 112 also powers a drive system (not shown) for propelling machine 100 on ground engaging devices 110. A hydraulic actuator system 116 is driven by power source 112 to actuate an implement system 118. Other machine 100 systems may also be powered by power source 112 as would be known by ordinary persons skilled in the art now or in the future.

Implement system 118 is coupled with frame 104, and includes an implement 122, linkages 126 configured to couple with implement 122, and one or more hydraulic actuators 123 coupled with frame 104 and with linkages 126 for maneuvering implement 122 to perform work. In the embodiment illustrated, a lift hydraulic cylinder assembly 128, and a tilt hydraulic cylinder assembly 130 are included for actuating a lift arm 120 and a tilt arm 121 to lift, lower, and tilt a bucket 124 in a conventional manner.

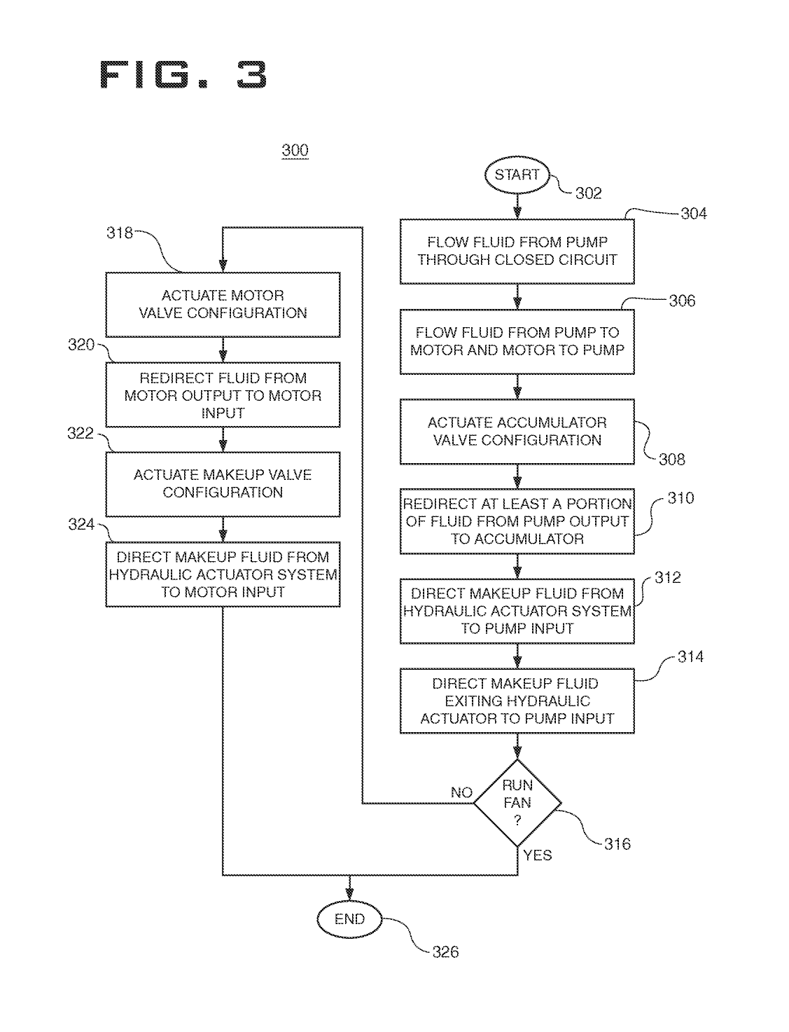

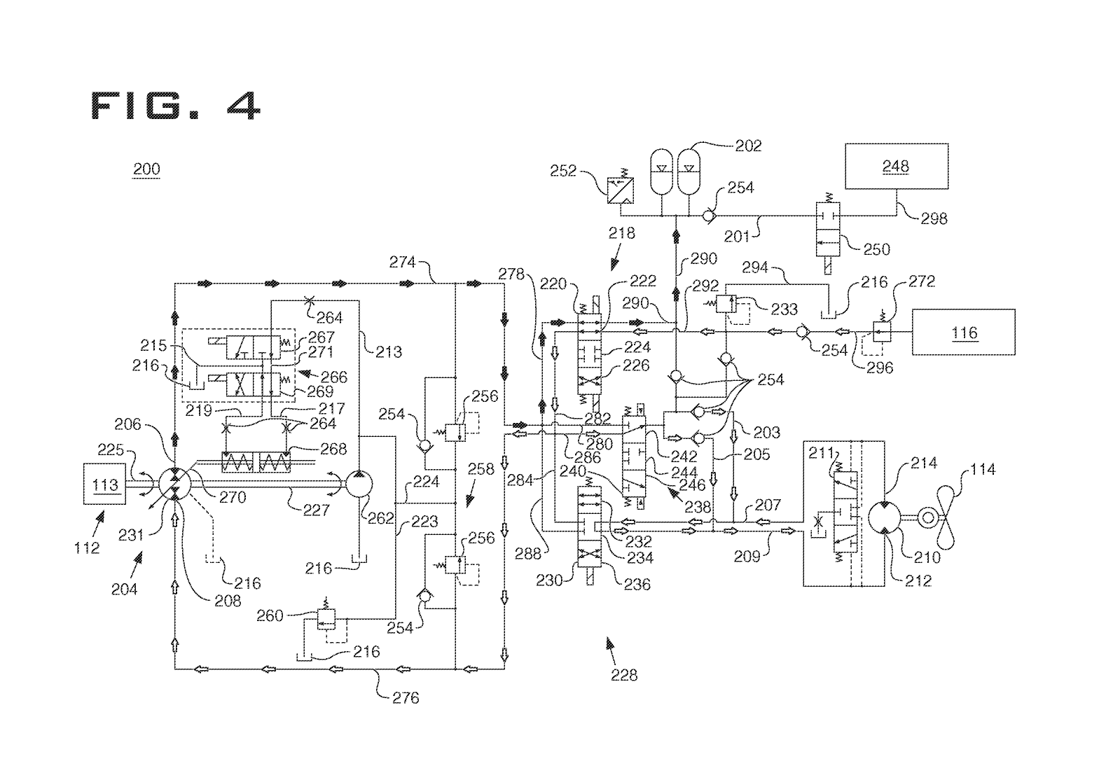

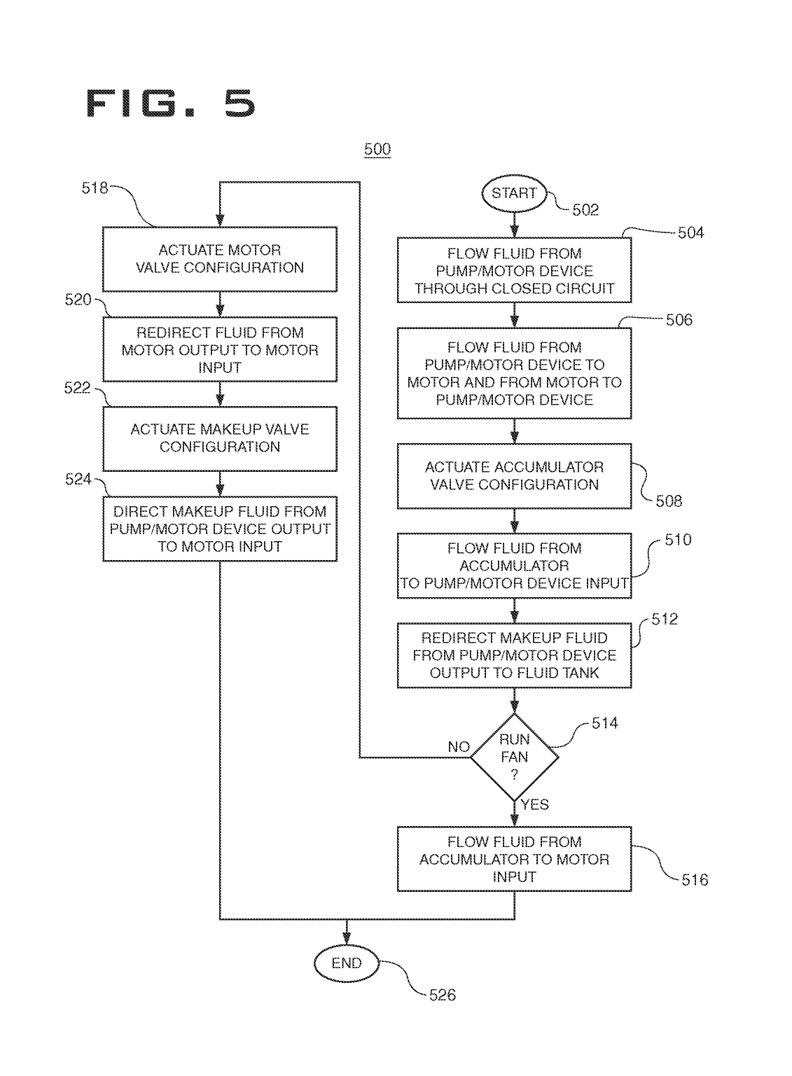

Referring now to FIG. 2, an embodiment of hydraulic system 200 is illustrated. FIGS. 4, 6, and 7 illustrate the same embodiment of hydraulic system 200 with valve configurations in different positions to illustrate the methods described in relation to FIGS. 3 and 5. In the schematics of FIGS. 2, 4, 6, and 7 Solid arrows generally depict the flow of high pressure fluid, while outlined arrows depict the flow of low pressure fluid.

Hydraulic system 200 includes a primary pump 204, a hydraulic motor 210, an accumulator 202, and the hydraulic actuator system 116. The primary pump 204 includes a pump input port 208 and a pump output port 206. The motor 210 includes a motor input port 212 selectively fluidly connected to one of the pump output port 206 and the pump input port 208 through a motor valve configuration 228. The motor 210 also includes a motor output port 214 selectively fluidly connected to the other of the pump output port 206 and the pump input port 208 through the motor valve configuration 228. The accumulator 202 is selectively connected to the pump output port 206 for charging through an accumulator valve configuration 218. The hydraulic actuator system 116 is configured to power an actuator and is selectively fluidly connected to the pump input port 208 through accumulator valve configuration 218.

In the illustrated embodiment, motor 210 is drivingly connected with the fan 114. Engine 113 may drive primary pump 204 via mechanical output 225 to draw in low-pressure fluid and discharge the fluid at an elevated pressure. Motor 210 may receive and convert the pressurized fluid to mechanical power that drives fan 114 to generate a flow of air. The flow of air may be used to cool engine 113 directly and/or indirectly by way of a heat exchanger (not shown). In alternative embodiments, motor 210 may drive and/or actuate other machine (100) devices.

Hydraulic system 200 is configurable through actuating accumulator valve configuration 218, motor valve configuration 228, and/or a makeup valve configuration 238 to different positions; to charge or discharge the accumulator 202, while either driving fan 114, or not driving fan 114. FIG. 2 illustrates hydraulic system 200 in a configuration which charges accumulator 202, and drives fan 114. Other configurations of hydraulic system 200 will be explained in relation to the flow charts in FIGS. 3 and 5, and the hydraulic system schematics of FIGS. 4, 6, and 7.

Primary pump 204 may include an over-center, variable-displacement or variable-delivery pump/motor device 231 driven by engine 113 to pressurize fluid. In the example depicted, pump/motor device 231 embodies a rotary or piston-driven pump having a crankshaft (not shown) connected to engine 113 via mechanical output 225 such that an output rotation of engine 113 results in a corresponding pumping motion of primary pump 204. The pumping motion of pump/motor device 231 functions to draw in low-pressure fluid through pump input port 208 and discharge fluid at a higher pressure from pump output port 206. The displacement of pump/motor device 231, and thus the fluid flow from the pump output port 206, may be controlled by varying the angle of a swashplate 270 as is known by ordinary persons skilled in the art.

The pump/motor device 231 may act as a motor when pressurized fluid enters pump input port 206 and drains from pump output port 208. The flow of pressurized fluid to pump input port 206 and the draining of fluid from pump output port 208 may create a pressure differential across the pump/motor device 231 that causes driven element(s) (not shown) in pump/motor device 231 to move or rotate, and drive mechanical output 225 to provide power to machine 100. The direction and rate of fluid flow through pump/motor device 231 and the angle of swashplate 270 may determine the speed and torque output to mechanical output 225.

In the depicted embodiment, motor 210 includes a fixed displacement, rotary- or piston-type hydraulic motor movable by an imbalance of pressure acting on a driven element (not shown), for example an impeller or a piston. Fluid pressurized by pump/motor 231 may be directed into motor 210 via conduits and the motor valve configuration 228 and returned from motor 210 via conduits and the motor valve configuration 228. The direction of pressurized fluid to one side of the driven element and the draining of fluid from an opposing side of the driven element may create a pressure differential across the driven element (not shown) that causes the driven element to move or rotate. The direction and rate of fluid flow through motor 210 may determine the rotational direction and speed of motor 210 and fan 114, while the pressure imbalance of motor 210 may determine the torque output.

Fan 114 may be disposed proximate a liquid-to-air or air-to-air heat exchanger (not shown) and configured to produce a flow of air directed through channels of the exchanger for heat transfer with coolant or combustion air therein. Fan 114 may include a plurality of blades connected to motor 210 and be driven by motor 210 at a speed corresponding to a desired flow rate of air and/or a desired engine coolant temperature.

In the illustrated embodiment, accumulator valve configuration 218 includes a four port, three position directional accumulator control valve 220. The accumulator control valve 220 is spring biased to a closed position 224, and may be actuated by solenoids to a first open position 222, or a second open position 226. One of the accumulator control valve 220 ports is fluidly connected to the pump output port 206, another is fluidly connected to the pump input port 206, another is fluidly connected to the accumulator 202, and another is fluidly connected to the fluid tank 216 and/or the hydraulic actuator system 116.

When accumulator control valve 220 is in the first open position 222, as illustrated in FIGS. 2 and 4, the pump output port 208 is fluidly connected to the accumulator 202, and the hydraulic actuator system 116 is fluidly connected to the pump input port 208, for charging accumulator 202.

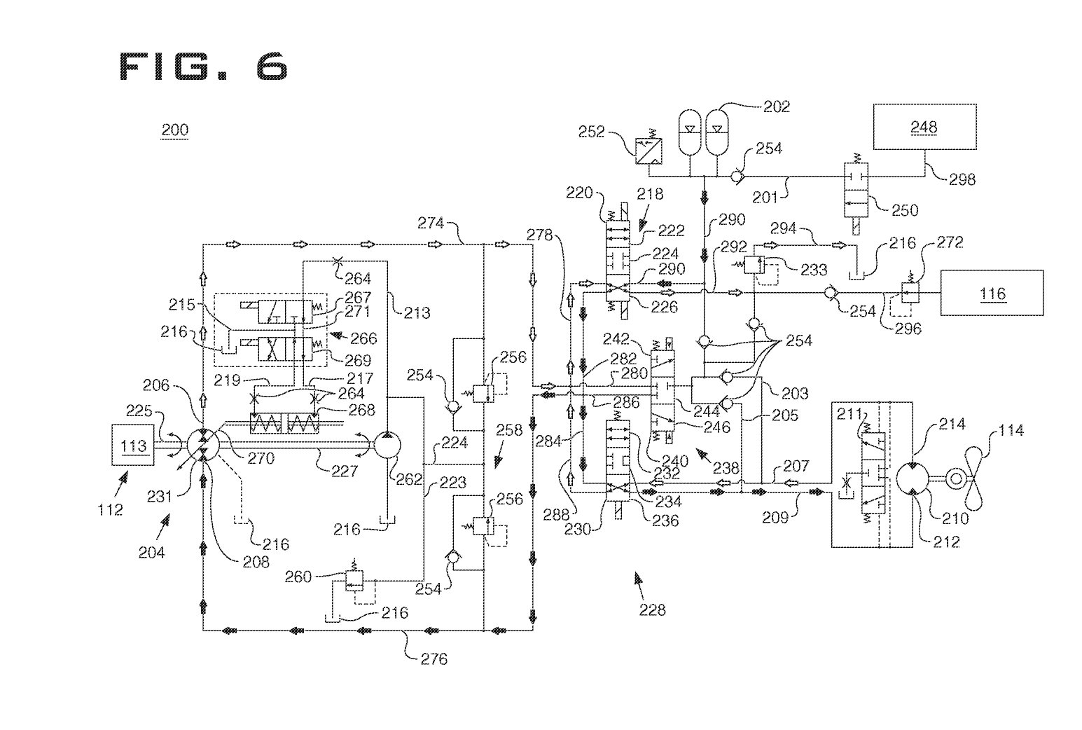

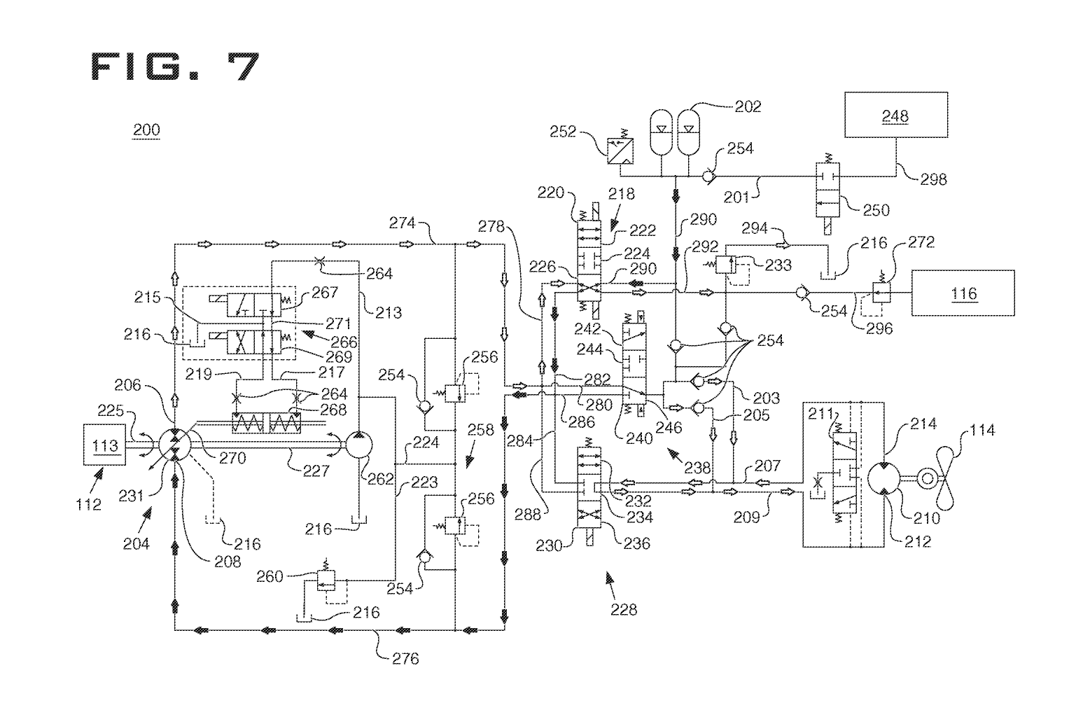

When accumulator control valve 220 is in the second open position 226 as illustrated in FIGS. 6 and 7, the pump output port 208 is fluidly connected to the fluid tank 216, and the hydraulic accumulator 202 is fluidly connected to the pump input port 208, for discharging accumulator 202. When accumulator control valve 220 is in the closed position 224 (not illustrated), the accumulator 202 is not connected to the primary pump 204. With accumulator control valve 220 in the closed position, pump/motor device 231 may drive motor 210 through the motor valve configuration 228, or pump/motor device 231 may be run at zero displacement.

Although accumulator control valve 220 is shown as a solenoid actuated valve, accumulator control valve 220 may be actuated by other means, for example by hydraulic or pneumatic pilot control, or by mechanical or manual means. It is contemplated that accumulator valve configuration 218 may include other multiple or single valve configurations in place of, or in addition to accumulator control valve 220 that would be known by ordinary persons skilled in the art now or in the future.

In the illustrated embodiment, motor valve configuration 228 includes a four port, three position, directional motor control valve 230. The motor control valve 230 is spring biased to a closed position 234, and may be actuated by solenoids to a first drive position 232, or a second drive position 236. One of the motor control valve 230 ports is fluidly connected to the pump output port 206, another is fluidly connected to the pump input port 206, another is fluidly connected to the motor input port 212, and another is fluidly connected the motor output port 214.

When motor control valve 230 is in the first drive position 232, and accumulator control valve 220 is in the first open position 222, as illustrated in FIG. 2, the pump output port 208 is fluidly connected to the motor input port 212, and the output motor port 214 is fluidly connected to the pump input port 208, for driving motor 210 with pump/motor device 231. When the hydraulic system 200 is in this configuration, pump/motor device 231 charges accumulator 202 and drives motor 210.

When motor control valve 230 is in the first drive position 232, and accumulator control valve 220 is in the closed position (not shown) the pump output port 208 is fluidly connected to the motor input port 212, and the output motor port 214 is fluidly connected to the pump input port 208, for driving motor 210 with pump/motor device 231. When the hydraulic system 200 is in this configuration, pump/motor device 231 drives motor 210, but does not charge the accumulator.

When motor control valve 230 is in the second drive position 236, and accumulator control valve 220 is in the second open position 226, as illustrated in FIG. 6, the accumulator 202 is fluidly connected to the motor input port 212, and the motor output port 214 is fluidly connected to the fluid tank 216, for driving motor 210 with accumulator 202. When the hydraulic system 200 is in this configuration, accumulator 202 drives motor 210 and may provide power to machine 100.

When motor control valve 230 is in the second drive position 236, and accumulator control valve 220 is in the closed position 224 (not shown) the pump output port 208 is fluidly connected to the motor output port 214, and the motor input port 214 is fluidly connected to the pump output port, for driving motor 210 in reverse with pump/motor device 231.

When motor control valve 230 is in the closed position 234, as illustrated in FIGS. 4 and 7, motor 210 is not being driven and motor input 212 is fluidly connected to motor output 214. When motor control valve 230 is in the closed position, the makeup valve configuration 238 may provide low pressure fluid to conduits 207, 209 to replace fluid lost through leakage or flushing with a flushing valve 211.

In FIGS. 2, 4, 6, and 7 the schematics of the hydraulic system 200 have lines connecting numbered elements, and throughout this description they will be referred to as conduits and often by their element numbers. It should be understood that when a conduit is called out as an element number, it does not necessarily mean it is a separate physical conduit such as a hose. Rather the labeled conduits are meant to depict connections as is known in the art. Connections may include hoses, passages in manifolds, tubes, or other type conduits that fluid may flow through. Separate lines with different element numbers do not necessarily mean separate conduits. Rather, connections between elements in the hydraulic system 200 in the depicted embodiment may be physically made in any manner that is known in the art consistent with the schematic.

Although motor control valve 230 is shown as a solenoid actuated valve, motor control valve 230 may be actuated by other means, for example by hydraulic or pneumatic pilot control, or by mechanical or manual means. It is contemplated that motor valve configuration 228 may include other multiple or single valve configurations in place of, or in addition to motor control valve 230 that would be known by ordinary persons skilled in the art now or in the future.

In the illustrated embodiment, makeup valve configuration 238 includes a three port, three position, directional makeup control valve 240. The makeup control valve 240 is spring biased to a closed position 244, and may be actuated by pilot fluid to a first makeup position 242, or a second makeup position 246. One of the makeup control valve 230 ports is fluidly connected to the pump output port 206 and one of the accumulator control valve 220 ports. Another makeup control valve 240 port is fluidly connected to the pump input port 206 and another accumulator control valve 220 port. Another makeup control valve 220 port is fluidly connected to the motor input port 212, the motor output port 214, and the accumulator 202 through check valves 254.

When the makeup control valve 240 is in one of the makeup positions 242, 246 as shown in relation to FIGS. 4 and 7, low pressure fluid flow from the pump/motor device 231 or the hydraulic actuator system 116 is directed through check valves 254 to conduits 207 and 209 to replace lost fluid. Fluid may be lost due to leakage or flushing. In addition, makeup control valve 240, when in an makeup position 242, 246 allows pump/motor device 231 to charge accumulator 202 to a minimum level at system start-up.

Although makeup control valve 240 is shown as a pilot actuated valve, makeup control valve 240 may be actuated by other means, for example by solenoid or pneumatic pilot control, or by mechanical or manual means. It is contemplated that makeup valve configuration 238 may include other multiple or single valve configurations in place of, or in addition to makeup control valve 240 that would be known by ordinary persons skilled in the art now or in the future.

Accumulator 202 includes a high pressure accumulator and is configured to store and release hydraulic energy. Accumulator 202 may be a gas accumulator, for example, a nitrogen accumulator, as is known in the art. Accumulator 202 may be charged by pump/motor device 231, or may drive pump/motor device 231, as is described in relation to FIGS. 3 and 5. Accumulator 202 may also drive motor 210, which in turn drives fan 114.

Hydraulic system 200 may include another hydraulic system 248 which may be configured to selectively fluidly connect to accumulator 202, to charge accumulator 202. For example, hydraulic circuit 248 may include a brake system (not shown), a steering system (not shown), or a hydrostatic transmission (not shown). In the depicted embodiment, hydraulic system 248 is selectively, fluidly connected to accumulator 202 via conduits 298 and 201 through a two position, solenoid activated, spring biased closed, directional valve 250, and a check valve 254. A controller (not shown) or other control means may generate signals to connect the hydraulic system 248 to the accumulator 202 for charging as is known in the art.

Hydraulic system 200 may include a pressure sensor 252 configured to generate a signal indicative of the fluid pressure at accumulator 202. The pressure sensor 252 may include a pressure transducer as is known in the art.

In the depicted embodiment, hydraulic system 200 includes a charge pump 262 for pressurizing and discharging pilot fluid. Engine 113 is drivingly connected to charge pump 262 via mechanical output 225 such that an output rotation of engine 113 results in a corresponding pumping motion of charge pump 262. The pumping motion of charge pump 262 functions to draw in low-pressure fluid from the fluid tank 216 and discharge pilot fluid at a higher pressure into conduits 213 and 224. In the depicted embodiment, charge pump 262 includes a fixed displacement pump.

Charge pump 262 selectively fluidly connects to displacement actuator 268 to affect a displacement change of pump/motor device 231. Displacement actuator 268, as illustrated, embodies a double-acting, spring-biased cylinder connected to move swashplate 270 and adjust the displacement of pump/motor device 231. When pilot fluid of a sufficient pressure is introduced into one end of displacement actuator 268, displacement actuator 268 changes the angle of swashplate 270 by an amount corresponding to the pressure of the fluid.

Other embodiments of hydraulic system 200 may include alternative displacement actuators and displacement adjusting mechanisms other than a cylinder and swashplate to adjust the pressure of fluid being discharged from primary pump 204 as is known in the art.

In the depicted embodiment, a swashplate control valve configuration 266 controls which end of displacement actuator 268 receives pressurized pilot fluid and, accordingly, in which direction (i.e., which of a displacement-increasing and a displacement-decreasing direction) the displacement-adjusting mechanism of pump/motor device 231 is moved by displacement actuator 268. As depicted, valve configuration 266 includes a first swashplate control valve 267 and a second swashplate control valve 269. Although depicted as being actuated by solenoids, the swashplate control valves 267, 269 may be actuated by other means, for example by hydraulic or pneumatic pilot control, or by mechanical or manual means.

In the depicted embodiment of valve configuration 266, first swashplate control valve 267 includes a two position directional control valve, spring biased to a first position directing flow from conduit 213 to conduit 271. First swashplate control valve 267 may be actuated by a solenoid to a second position where flow from conduit 213 is directed to tank through conduit 215. Second swashplate control valve 269 includes a two position directional control valve, spring biased to a first position directing flow from conduit 271 through conduit 217 to a first end of displacement actuator 268 Second swashplate control valve 269 may be actuated by a solenoid to a second position where flow from conduit 271 is directed through conduit 219 to a second opposing end of displacement actuator 268.

When the first end of displacement actuator 268 is receiving pressurized pilot fluid (i.e., when control valve 267 is in the first position and control valve 269 is in the first position), the second end of displacement actuator 268 fluidly connects to fluid tank 216 via control valve 269. Similarly, when the second end of displacement actuator 268 is receiving pressurized pilot fluid (i.e., when control valve 267 is in the first position and control valve 269 is in the second position), the first end of displacement actuator 268 fluidly connects to fluid tank 216 via control valve 269.

In other alternative embodiments, other valves or combination of valves may be used to selectively connect the charge pump 262 with displacement actuator 268 to adjust the displacement of pump/motor device 231.

One or more restrictive orifices 264 associated with pilot fluid conduits 213, 217, and 219 may reduce pressure fluctuations in the pilot fluid entering and exiting the ends of displacement actuator 268 and, thereby, stabilize fluctuations in a speed of pump displacement changes.

Hydraulic system 200, as depicted, includes a makeup/relief passage 258. Makeup/relief passage 258 may provide makeup fluid to conduits 274 and 276 to assist in ensuring that hydraulic system 200 remains full of fluid, and also provide a leak path for high-pressure fluid within conduits 274 and 276 such that damage to the components of hydraulic system 200 may be avoided.

One or more makeup valves, for example check valves 254, may be located within makeup/relief passage 258 to selectively connect the output from charge pump 262 with fluid conduits 274 and 276 based on pressures of fluid in the different passages. That is, when a pressure within conduits 274 or 276 falls below a pressure of fluid discharged by charge pump 262, check valves 254 may open and allow fluid to pass from charge pump 262 into the respective conduit(s).

A pressure relief valve 260 may ensure that pilot fluid pressure does not exceed a pre-set maximum pressure. This pre-set maximum pressure may be adjustable. When pilot fluid exceeds the pre-set maximum pressure, pressure relief valve 260 opens and fluid flows through conduit 223 to the fluid tank 216. When pilot fluid returns to a pressure below the pre-set maximum pressure, pressure relief valve 260 again closes.

One or more relief valves 256 may also be located within makeup/relief passage 258. Relief valves 256 may be spring-biased and movable in response to a pressure of conduits 274 and/or 276 to selectively connect the respective conduit with a low-pressure conduit 224, thereby relieving excessive fluid pressures within conduits 274 and 276. Pressure relief valve 260 may then maintain a desired pressure within low-pressure conduit 224 by directing high pressure fluid through conduit 223 to the fluid tank 216.

The depicted embodiment includes a flushing valve 211 for flushing hydraulic fluid from the motor 210 and conduits 207 and 209. Flushing may sometimes be necessary to replace fluid containing debris or other contaminants or for cooling. Flushing valves are well known in the art.

In the depicted embodiment, hydraulic actuator system 116 is configured to selectively fluidly connect to the pump input port 208 through a pressure reducing valve 272, a check valve 254, and accumulator control valve 220. As is described in more detail in relation to FIGS. 3 and 5, hydraulic actuator system 116 provides low pressure makeup fluid to pump inlet 208 when pump/motor device 231 is charging accumulator 202. In the machine 100 embodiment depicted in FIG. 1, actuator system 116 actuates hydraulic cylinder assemblies 128, 130 to lift and tilt implement 122. In other embodiments hydraulic actuator system 116 may be any hydraulic actuator system which is configured to be able to selectively provide a low pressure supply of fluid to hydraulic system 200.

Pump output port 206 selectively fluidly connects to fluid tank 216 through accumulator control valve 220 and pressure relief valve 233. As will be described in more detail in relation to FIGS. 5, 6, and 7, when the accumulator control valve 220 is in the second open position 226, the accumulator 202 releases pressurized fluid to drive pump/motor device 231 to provide energy to machine 100. When accumulator 202 is discharging to the pump input port 208, low pressure fluid from the pump output port 206 is directed to the fluid tank 216 through accumulator control valve 220 and pressure relief valve 233.

### INDUSTRIAL APPLICABILITY

Power sources 112 for machines 100 may power multiple functions of the machine 100. For example, a power source 112, such as an engine 113, may power a propulsion system to move a machine 100 from site to site, an implement system 118 to perform work on a site, and auxiliary systems such as the hydraulic system 200 powering a fan 114, and/or operator comfort systems such as air conditioning. Generally, not all machine 100 systems draw maximum power simultaneously. But, traditionally, the power source 112 has been sized to power the load when all the machine 100 systems are operating at once.

With a hybrid power system including an accumulator 202, energy may be stored in the accumulator 202 when the load on the power source 112 is less than it's capacity. When the load on the power source 112 is above its' capacity, energy stored in the accumulator 202 may be released to assist in meeting the machine 100 power demand. This allows a smaller power source 112 to be specified for the machine 100.

Referring now to FIG. 3, a first embodiment of the method 300, for charging an accumulator 202 and driving a hydraulic motor 210 is depicted in steps 302 through 316 and step 326 of the flow chart in FIG. 3 and in relation to FIG. 2. This first embodiment of method 300 includes allowing fluid from an output port 206 of a hydraulic pump 204 to flow to the accumulator 202 to charge the accumulator 202; allowing fluid from the output port 206 of the hydraulic pump 204 to flow to an input port 212 of the hydraulic motor 210 to drive the hydraulic motor 210; directing makeup fluid from a hydraulic actuator system 116 to an input port 208 of the hydraulic pump 204; and allowing fluid from an output port 214 of the hydraulic motor 210 to flow to the input port 208 of the hydraulic pump 204.

A second embodiment of method 300 for charging an accumulator 202 is depicted in steps 302 through 326 of the flow chart in FIG. 3 and in relation to FIG. 2. This second embodiment of method 300 includes allowing fluid to flow from an output port 206 of a hydraulic pump 204, through a closed circuit, to an input port 208 of the hydraulic pump 204; redirecting fluid from the output port 208 of the hydraulic pump 204 to flow to the accumulator 202, and directing makeup fluid from a hydraulic actuator system 116 to flow to the input port 208 of the hydraulic pump 204.

The first embodiment of method 300, for charging an accumulator 202 and driving a hydraulic motor 210, starts at 302 and proceeds to 304. In step 304, fluid is allowed to flow from the hydraulic pump 204 through a closed circuit. Closed hydraulic systems are generally more fuel efficient than open hydraulic systems. Instead of dumping fluid, and energy, back into the fluid tank 216, a closed hydraulic system circulates the fluid back through the pump 204. The method 300 proceeds to step 304.

In step 304, fluid flows from the hydraulic pump 204 to the hydraulic motor 210 and back to the hydraulic pump 204. Step 304 is one embodiment of the flow through a closed circuit of step 302 as depicted in the system of FIGS. 2, 4, and 6-7. Referring to FIG. 2, when accumulator control valve 220 is in the closed position 224 (not shown), the makeup control valve 240 is in the closed position 244, and the motor control valve 230 is in the first open position 232; fluid flows from the output port 206 of hydraulic pump 204 through conduit 274, through conduit 288, through the motor control valve 230, through conduit 209 to the input port 212 of the hydraulic motor 210. The fluid flows through the hydraulic motor 210 and out the output port 214, through conduit 207, through the motor control valve 230, through conduit 284, through conduit 276, and to the input port of hydraulic pump 204. The method proceeds to step 308.

In step 308, at least one valve in the accumulator valve configuration 218 is actuated. In the embodiment of step 308 depicted in relation to FIG. 2, the accumulator control valve 220 is actuated through a solenoid control to the first open position 222. The method 300 proceeds to step 310.

In step 310 at least a portion of fluid is redirected from the pump output 206 to the accumulator 202. Fluid exiting the pump 204 is at a first pressure high enough that the redirected fluid charges the accumulator 202. In the embodiment depicted in FIG. 2, when the accumulator control valve 220 is actuated to move to the first open position 222 the pump output port 206 is connected with the accumulator 202. A portion of the fluid flowing from pump 204 flows to the accumulator 202. The fluid flows through conduit 274, through conduit 278, through accumulator control valve 220, and through conduit 290 to accumulator 202. Some fluid from pump 204 continues to flow through motor control valve 230 to drive the hydraulic motor 210. The method 300 proceeds to 312.

In step 312, makeup fluid from the hydraulic actuator system 116 is directed to the pump input 208. Hydraulic pumps 204 may be damaged if the flow of fluid entering and exiting the pump 204 is not substantially equal. When at least a portion of fluid from the pump 204 is redirected to the accumulator 202, that fluid does not return to the pump input port 208, potentially causing an imbalance of flow volume between the pump inlet 208 and outlet 206, and potentially damaging the pump 204. In the embodiment depicted in the embodiment in FIG. 2, when the accumulator control valve 220 is actuated to the first open position 222, fluid from the actuator circuit 116 flows through pressure reducing valve 272, through conduit 296, through check valve 254, through accumulator control valve 220, through conduit 282, and through conduit 276 to pump inlet 208. The makeup fluid directed from actuator system 116 may be at a second pressure. The second pressure may be lower than the first pressure. The method 300 proceeds to step 314.

In step 314 the makeup fluid from actuator system 116 directed to pump inlet 208 is fluid exiting a hydraulic actuator. Step 314 is an embodiment of step 312. The hydraulic actuator circuit 116 may be configured to power one or more actuators, such as hydraulic cylinder assemblies 128, 130, to actuate an implement 122. The makeup fluid may be fluid exiting one of the hydraulic cylinder assemblies 128, 130. The method 300 proceeds to step 316.

In step 316, logic in a controller (not shown) may determine whether the fan 114 should be run while the accumulator 202 is charging. Fan 114 may need to run while the accumulator 202 is charging to cool engine 113 or other machine 100 components. Load, current fluid temperature, atmospheric temperature and pressure, machine 100 speed, and/or other parameters may be used to determine whether running the fan 114 is necessary. In the first embodiment of method 300, the fan 114 runs while charging the accumulator, as depicted in FIG. 2. Therefore, the motor control valve 230 is kept in the first open position 232, and fluid from the pump output 206 continues to flow to and drive motor 210. Fluid continues to flow from the motor output 214 to the pump input 208. The method 300 proceeds to step 326 and ends.

The second embodiment of method 300, for charging an accumulator, starts at 302 and proceeds through steps 304 through 308 as explained in relation to the first embodiment of method 300 as described above.

In step 308, in the embodiment depicted in FIG. 4, all the fluid exiting the pump 204 is redirected to flow to the accumulator 202. Steps 312 and 314 of the second embodiment of method 300 are similar to the steps described in relation to the first embodiment above.

In step 316 the logic described above in relation to the first embodiment of the method 300 is similar, but the logic determines that running the fan 114 is not necessary. The method 300 then proceeds to step 318.

In step 318, as depicted in the embodiment in FIG. 4, motor control valve 230 is actuated to the closed position 234. In the closed position 234, motor control valve 230 connects conduit 207 to conduit 209, thus connecting the motor input 212 and motor output 214. The method 300 proceeds to step 320.

In step 320, fluid is redirected to flow from the motor output 214 to the motor input 212 through conduits 207 and 209 and through motor control valve 230. Ensuring that fluid continually flows through motor 210 provides lubrication and cooling benefits. The method 300 proceeds to step 322.

In step 322, as depicted in FIG. 4, the makeup control valve 240 is actuated to the first open position 242. The method 300 proceeds to step 324.

In step 324, as depicted in FIG. 4, fluid from the actuator circuit 116 is directed to the motor 210 to provide low pressure makeup fluid. Makeup fluid flows from the actuator circuit 116, through conduit 296, through pressure reducing valve 272, through check valve 254, through conduit 292, through accumulator control valve 220, through conduit 286, through makeup control valve 240, through conduits 203 and 205 to conduits 207 and 209 respectively, and to motor 210. Makeup fluid may be necessary as fluid may leak in the motor 210 circuit or be lost through flushing. The method 300 proceeds to step 326 and ends.

Referring now to FIG. 5, a method 500 for discharging the accumulator 202 is depicted. One first embodiment of the method 500, for discharging the accumulator 202 and driving the motor 210, includes allowing fluid to flow from the output port 206 of the pump/motor device 231 to the input port 212 of the hydraulic motor 210, through the hydraulic motor 210, and from the output port 214 of the hydraulic motor 210 to the input port 208 of the pump/motor device 231; allowing fluid to flow from the accumulator 202 to the input port 208 of the pump/motor device 231 to drive the pump/motor device 231; allowing fluid to flow from the accumulator 202 to the input port 212 of the hydraulic motor 210 to drive the motor 210; and redirecting the flow of fluid from the output port 214 of the hydraulic motor 210 and the output port 206 of the pump/motor device 231 to a fluid tank 216. The first embodiment of method 500 is depicted in steps 502 through 526 of the flow chart in FIG. 5, and depicted in relation to an embodiment of a hydraulic system 200 in FIG. 6.

A second embodiment of the method 500, for discharging the accumulator 202, includes allowing fluid to flow from the output port 206 of a pump/motor device 231, through a closed circuit, to the input port 208 of the pump/motor device 231; allowing fluid to flow from the accumulator 202 to the input port 206 of the pump/motor device 231 to drive the pump/motor device 231; and redirecting the flow of fluid from the output port 206 of the pump/motor device 231 to a fluid tank 216. The second embodiment of method 500 is depicted in steps 502 through 516, and 526 of the flow chart in FIG. 5, and depicted in relation to an embodiment of a hydraulic system in FIG. 7.

The first embodiment of method 500, for discharging the accumulator 202 and driving the hydraulic motor 210, starts at 502 and proceeds to 504. Steps 504 and 506 are similar to steps 304 and 306 respectively, described in relation to FIG. 3. The method 500 proceeds to step 508.

In step 508, at least one valve in the accumulator valve configuration 218 is actuated. As depicted in relation to FIG. 6, the accumulator control valve 220 is actuated to the second open position 226. The method 500 proceeds to step 510.

In step 510 fluid is allowed to flow from the accumulator 202 to the input port 206 of the pump/motor device 231 to drive the pump/motor device 231. In the embodiment depicted in FIG. 6, fluid flows from accumulator 202 through conduit 290, through accumulator control valve 220, through conduit 282, and through conduit 276 to pump input port 208. Swashplate control valve configuration 266 may also be actuated to move the displacement actuator 268 to change the swashplate 270 angle such that pump/motor device 231 will function as a motor. The fluid flowing from the accumulator may be at a first pressure. The fluid may enter pump/motor device 231 and create an imbalance of pressure acting on a driven element (not shown) in the pump/motor device 210. This pressure imbalance may cause the driven element to rotate, and in turn drive mechanical output 225 of engine 113 to provide power to the machine 100. Method 500 proceeds to step 512.

In step 512, fluid is redirected from the output port 206 of pump/motor device 231 to the fluid tank 216. In the closed circuit depicted in FIG. 6, when pressurized fluid stored in the accumulator 202 is released, flows to, and enters the input port 208 of the pump/motor device 231, an equal amount of fluid must be discharged to another receptacle or fluid receiving device, rather than being circulated through the circuit and entering the inlet port 208 of the pump/motor device 231. This replacement, or additionally discharged, fluid may be called makeup fluid. If the fluid flowing from both the pump output port 206 and the accumulator 202 were to flow into the input port 208, there would be more fluid flowing into the pump/motor device 231 than out of the pump/motor device 231. This imbalance might damage the pump/motor device 231. As depicted in the embodiment in FIG. 6, when accumulator control valve 220 is actuated to the second open position 226, the output port 206 is fluidly connected to the fluid tank 216. Fluid flows from the pump output port 206, through conduit 274, through conduit 278, through accumulator control valve 220, through conduit 292, through pressure relief valve 233, and through conduit 294 to the fluid tank 216. The makeup fluid flowing from the output port 206 to the fluid tank 216 may be at a pressure lower than the first pressure. The method 500 proceeds to step 514.

In step 514, logic in a controller (not shown) may determine whether the fan 114 should be run while the accumulator 202 is discharging. Fan 114 may need to run while the accumulator 202 is discharging to cool engine 113 or other machine 100 components. Load, current fluid temperature, atmospheric temperature and pressure, machine 100 speed, and/or other parameters may be used to determine whether running the fan 114 is necessary. In the first embodiment of method 500, the fan 114 runs while discharging the accumulator, as depicted in FIG. 6. The method 500 proceeds to step 516.

In step 516, fluid is allowed to flow from the accumulator 202 to the input port 212 of the hydraulic motor 210 to drive the hydraulic motor 210. In the embodiment depicted in FIG. 6, motor control valve 230 is actuated to the second open position 236. When the accumulator control valve 220 is in the second open position 226, pressurized fluid flows from the accumulator 202, through conduit 290, through the accumulator control valve 220, through conduit 282, through conduit 284, through the motor control valve 230, and through conduit 209 to the motor input port 212. The pressurized fluid entering motor 210 drives the fan 114 as described above.

As depicted in FIG. 6, when the accumulator control valve 220 is in the second open position 226, and the motor control valve 230 is in the second open position 236, fluid from the output port 214 of the motor 210 is redirected as makeup fluid to the fluid tank 216. The fluid flows from the output port 214, through conduit 207, through motor control valve 230, through conduit 288, through conduit 278, through the accumulator control valve 220, through conduit 292, through the pressure relief valve 233, and through conduit 294 to the fluid tank 216. In alternative embodiments fluid from the output port 214 of the motor 210 may flow to the input port 208 of the pump/motor device 231, through the pump/motor device 231, exit the output port 206 of the pump/motor device, and then flow to the fluid tank 216. The method 500 proceeds to step 526 and ends.

In step 518, at least one valve in the motor valve configuration 228 is actuated to a position redirecting fluid to flow from the output port 214 of the hydraulic motor 210 to the input port

The second embodiment of method 500, for discharging an accumulator, starts at 502 and proceeds to 504. Steps 504 through 512 are similar to steps 504 through 512 of the first embodiment of method 500 as described above. Step 514 is similar to step 514 of the first embodiment of method 500 as described above, except logic in the controller determines that it is not necessary and the method 500 proceeds to step 518.

In step 518 at least one valve in the motor valve configuration 228 is actuated to a position redirecting fluid to flow from the output port 214 of the hydraulic motor 210 to the input port 212 of the hydraulic motor 210. In the embodiment depicted in FIG. 7, motor control valve 230 is actuated to the closed position 234. The method 500 proceeds to step 520.

In step 520, fluid is redirected to flow from the output port 214 of the hydraulic motor 210 to the input port 212 of the hydraulic motor 210. As depicted in the embodiment of FIG. 7, when motor control valve 230 is in the closed position 234, fluid flows from the motor output 214 to the motor input 212 through conduits 207 and 209 and through motor control valve 230. Ensuring that fluid continually flows through motor 210 provides lubrication and cooling benefits. The method 500 proceeds to step 522.

In step 522, at least one valve in a makeup valve configuration 240 is actuated to a position allowing makeup fluid to flow to the input port 212 of the hydraulic motor 210. In the embodiment depicted in FIG. 7, the makeup control valve 240 is actuated to the second makeup position 246. The method 500 proceeds to step 524.

In step 524, makeup fluid is directed to flow to the input port 212 of the hydraulic motor 210. In the embodiment depicted in FIG. 7, makeup fluid is directed from the pump output port 206 to flow to the motor 210. Makeup fluid flows from pump output port 206, through conduit 274, through conduit 280, through makeup control valve 240, through conduits 203 and 205 to conduits 207 and 209 respectively, and to motor 210. Makeup fluid may be necessary as fluid may leak in the motor 210 circuit or be lost through flushing. The method 500 proceeds to step 526 and ends.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

What is claimed is:

1. A method for charging an accumulator, comprising:
allowing fluid to flow from an output port of a hydraulic pump, through a closed circuit, to an input port of the hydraulic pump,
redirecting fluid from the output port of the hydraulic pump to flow to the accumulator, and
directing makeup fluid from a hydraulic actuator system to flow to the input port of the hydraulic pump.

2. The method of claim 1, wherein the fluid from a hydraulic actuator system includes fluid exiting a hydraulic actuator.

3. The method of claim 1, further including actuating at least one valve in an accumulator valve configuration to a position to redirect fluid at a first pressure to flow from the output port of the hydraulic pump to the accumulator, and directing makeup fluid at a second pressure, the second pressure lower than the first pressure, to flow from the hydraulic actuator system to the input port of the hydraulic pump.

4. The method of claim 1, further including;
allowing fluid to flow from the output port of the hydraulic pump to an input port of a hydraulic motor, through the hydraulic motor, out of an output port of the hydraulic motor, and to the input port of the hydraulic pump,
redirecting fluid from the output port of the hydraulic motor to flow to the input port of the hydraulic motor, and
directing makeup fluid from the hydraulic actuator circuit to flow to the input port of the hydraulic motor.

5. The method of claim 4, further including actuating at least one valve in a makeup valve configuration to a position allowing makeup fluid to flow from the hydraulic actuator circuit to the hydraulic motor.

6. The method of claim 4, further including actuating at least one valve in a motor valve configuration to a position allowing fluid to flow from the input port of the hydraulic motor to the output port of the hydraulic motor and through the hydraulic motor.

7. A method for discharging an accumulator, comprising:
allowing fluid to flow from the output port of a pump/motor device, through a closed circuit, to the input port of the pump/motor device,
allowing fluid to flow from the accumulator to the input port of the pump/motor device to drive the pump/motor device, and
redirecting the flow of fluid from the output port of the pump/motor device to a fluid tank.

8. The method of claim 7, further including
actuating at least one valve in an accumulator valve configuration to a position allowing;
fluid at a first pressure to flow from the accumulator to the input port of the pump/motor device, and
makeup fluid at a second pressure, the second pressure lower than the first pressure, to flow from the output port of the pump/motor device output port to the fluid tank.

9. The method of claim 7, further including driving a power outlet of a power source with the pump/motor device.

10. The method of claim 7, further including;
allowing fluid to flow from the output port of the pump/motor device to an input port of a hydraulic motor, through the hydraulic motor, out of an output port of the hydraulic motor, and to the input port of the pump/motor device,
redirecting the flow of fluid from the output port of the hydraulic motor to the input port of the hydraulic motor, and
directing makeup fluid to flow to the input port of the hydraulic motor.

11. The method of claim 10, further including actuating at least one valve in a makeup valve configuration to a position allowing makeup fluid to flow to the input port of the hydraulic motor.

12. The method of claim 10, further including actuating at least one valve in a motor valve configuration to a position redirecting fluid to flow from the output port of the hydraulic motor to the input port of the hydraulic motor.

13. A method for charging an accumulator and driving a hydraulic motor, comprising:
allowing fluid from an output port of a hydraulic pump to flow to the accumulator to charge the accumulator,
allowing fluid from the output port of the hydraulic pump to flow to an input port of the hydraulic motor to drive the hydraulic motor,
directing makeup fluid from a hydraulic actuator system to an input port of the hydraulic pump, and
allowing fluid from an output port of the hydraulic motor to flow to the input port of the hydraulic pump.

14. The method of claim 13, further including;
actuating at least one valve in an accumulator valve configuration to a position allowing;
fluid at a first pressure to flow from the output port of the hydraulic pump to the accumulator, and
fluid at a second pressure, the second pressure lower than the first pressure, to flow from the hydraulic actuator system to the input port of the hydraulic pump.

15. The method of claim 13, further including driving a fan with the hydraulic motor.

16. A method for discharging an accumulator and driving a hydraulic motor, comprising:
allowing fluid to flow from the output port of a pump/motor device to the input port of a hydraulic motor, through the hydraulic motor, and from the output port of the hydraulic motor to the input port of the pump/motor device,
allowing fluid to flow from the accumulator to the input port of the pump/motor device to drive the pump/motor device,
allowing fluid to flow from the accumulator to the input port of the hydraulic motor to drive the motor, and
redirecting the flow of fluid from the output port of the hydraulic motor and the output port of the pump/motor device to a fluid tank.

17. The method of claim 16, further including actuating at least one valve in an accumulator valve configuration to a position allowing,
fluid at a first pressure to flow from the accumulator to the input port of the pump/motor device, and
makeup fluid at a second pressure, lower than the first pressure, to flow from the output port of the pump/motor device to the fluid tank.

18. The method of claim 16, further including actuating at least one valve in a motor valve configuration to a position allowing,
fluid at the first pressure to flow from the accumulator to the input port of the hydraulic motor, and
fluid at a third pressure, the third pressure lower than the first pressure, to flow from the output port of the hydraulic motor to the fluid tank.

19. The method of claim 16, further including driving a fan with the hydraulic motor.

20. The method of claim 16, further including driving a power outlet of a power source with the pump/motor device.

21. A hydraulic system to charge and discharge an accumulator, comprising:
a variable displacement pump/motor including a pump input port and a pump output port,
a hydraulic motor, including a motor input port and a motor output port, wherein the motor input port is selectively fluidly connected to one of the pump input port and the pump output port, and the motor output port is selectively fluidly connected to the other of the pump input port and the pump output port,
an accumulator selectively fluidly connected to the pump output port, and
a hydraulic actuator system, configured to power an actuator, selectively fluidly connected to the pump input port.

22. The system of claim 21, including an accumulator valve configuration including a charging position and a discharging position, and
wherein the pump output port is fluidly connected with the accumulator, and the actuator system is fluidly connected to the pump input port when the accumulator valve configuration is in the charging position; and the pump output port is fluidly connected with the fluid tank, and the accumulator is fluidly connected to the pump input port when the accumulator valve configuration is in the discharging position.

23. The system of claim 21, further including an accumulator valve configuration including a charging position, and
wherein the pump output port is fluidly connected with the accumulator, and the actuator system is fluidly connected to the pump input port when the accumulator valve configuration is in the charging position.

24. The system of claim 21, further including a motor valve configuration including a driving position; and wherein the motor input port is fluidly connected to the pump output port, and the motor output port is fluidly connected to the pump input port when the motor valve configuration is in the driving position.

25. The system of claim 24, further including a makeup valve configuration including a makeup position, and
wherein the motor valve configuration includes a closed position; and the pump output port is fluidly connected to one of, the motor input port and the motor output port, when the motor valve configuration is in the closed position and the motor makeup valve configuration is in the makeup position.

26. The system of claim 24, wherein the motor input port is fluidly connected to the motor output port when the motor valve configuration is in the closed position.

27. The system of claim 21, further including a fan driven by the hydraulic motor.

28. The system of claim 27, further including a power source with a power output, drivingly connected with the variable displacement pump/motor.

29. The system of claim 28, wherein the power source includes an engine and the fan is configured to cool the engine.

30. The system of claim 21, wherein the actuator system includes a hydraulic system configured to actuate an implement on a machine.
